(19) United States
(12) Patent Application Publication
(10) Pub. No.: US 2008/0052537 A1
(43) Pub. Date: Feb. 28, 2008

(54) Storage device, write-back method, and computer product

(75) Inventor: Shinichi Nishizono, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/710,556

(22) Filed: Feb. 26, 2007

(30) Foreign Application Priority Data
Aug. 22, 2006 (JP) 2006-225662

(51) Int. Cl. G06F 11/30; H04L 9/00

(52) U.S. Cl. 713/193; 380/42

(57) ABSTRACT

In a redundant array of inexpensive disks (RAID) device, an encrypting unit encrypts data to be written back at a timing when a write-back processing unit performs a write-back of the data. The write-back processing unit stores the encrypted data in an encryption buffer, and then writes back the encrypted data stored in the encryption buffer to a disk.

### BACKGROUND OF THE INVENTION

1. Field of the Invention

The present invention relates to a technology for write-back of data from a primary storage unit to a secondary storage unit.

2. Description of the Related Art

A storage system is required to ensure security of confidential data stored in a storage device such as a hard disk. Therefore, a technology for encrypting the data stored in the storage device has been increasingly important in recent years.

In a conventional technology disclosed in Japanese Patent Application Laid-Open No. H09-259044, when data stored in a primary storage unit such as a cache memory is to be stored in a secondary storage unit such as a magnetic disk, the data is encrypted and then stored in the secondary storage unit. The technology enhances the security so that the data stored in the secondary storage unit is prevented from leaking to a third party who has malicious purposes.

However, in the conventional technology, after the data transmitted from an upstream device is stored in the primary storage unit, the data is encrypted, and then stored in the secondary storage unit. Therefore, it takes a long time to store the data in the secondary storage unit because of the encryption process.

Thus, there is a need of a technology for encrypting data such that the upstream device is unaware of a delay in response to input/output (I/O) processing due to the encryption process.

### SUMMARY OF THE INVENTION

It is an object of the present invention to at least partially solve the problems in the conventional technology.

According to an aspect of the present invention, a storage device that includes a primary storage unit and a secondary storage unit, the storage device being connected to an upstream device via a network, includes a first data processing unit that receives non-encrypted data from the upstream device and temporarily stores the non-encrypted data in the primary storage unit, and a second data processing unit that encrypts the non-encrypted data, and writes encrypted data to the secondary storage unit.

According to another aspect of the present invention, a write-back method for transferring data from a primary storage unit to a secondary storage unit of a storage device, the storage device being connected to an upstream device via a network, includes receiving non-encrypted data from the upstream device, storing the non-encrypted data in the primary storage unit, encrypting the non-encrypted data, and writing encrypted data to the secondary storage unit.

According to still another aspect of the present invention, a computer-readable recording medium stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining a data flow in a redundant array of inexpensive disks (RAID) device according to an embodiment of the present invention;

FIG. 2 is a block diagram of the RAID device;

FIG. 3 is a flowchart of an encryption process performed by a control unit shown in FIG. 2;

FIG. 4 is a detailed flowchart of a buffer area adjustment process shown in FIG. 3; and

FIG. 5 is a block diagram of a hardware configuration of a computer that executes a computer program for implementing the RAID device.

### DETAILED DESCRIPTION OF THE PREFERRED EMBODIMENTS

Exemplary embodiments of the present invention are explained in detail below with reference to the accompanying drawings.

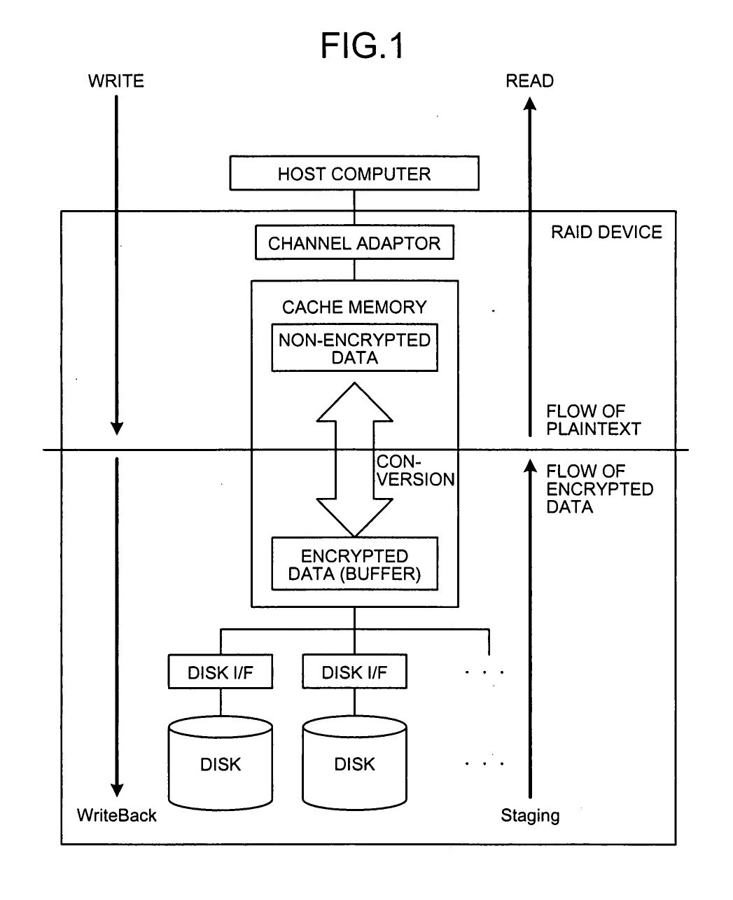

A redundant array of inexpensive disks (RAID) device according to an embodiment of the present invention is described below with reference to FIG. 1. Upon retrieving data (to be written to a disk) from a host computer, the RAID device temporarily stores the data in a cache memory. To write back the data stored in the cache memory to the disk (performing a write-back to the disk), the RAID device encrypts the data (the write-back target data) at write-back time. Then, the RAID device stores the encrypted data in a buffer in the cache memory, and immediately writes back the encrypted data stored in the buffer to the disk.

The RAID device encrypts data at the write-back time on a background regardless of I/O processing from an upstream device, i.e., asynchronously with the I/O processing from the upstream device, and then promptly writes back the encrypted data to the disk. Therefore, the RAID device can encrypt data such that the upstream device is unaware of the encryption process (the upstream device is unaware of a delay in response to the I/O processing due to the encryption process).

The data stored in the buffer is promptly written back to the disk. Namely, the buffer in the cache memory can be released promptly. Therefore, it is possible to use a storage area in the cache memory efficiently.

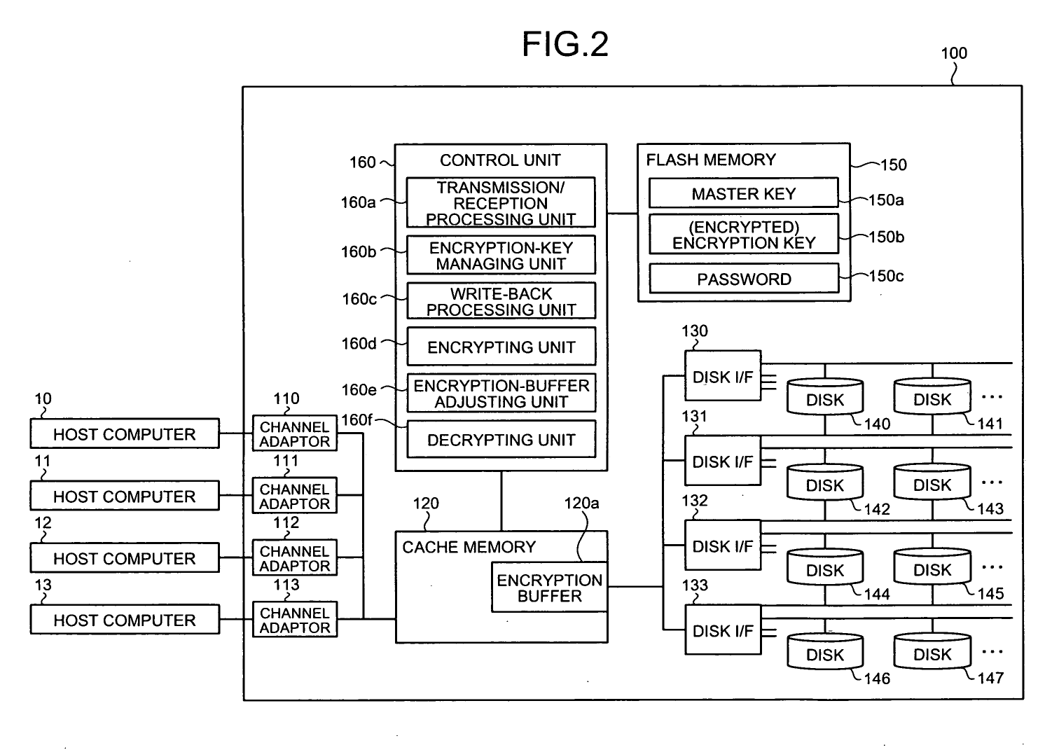

FIG. 2 is a block diagram of a RAID device 100 according to the embodiment. The RAID device 100 includes channel adaptors 110 to 113, a cache memory 120, disk interfaces (disk I/Fs) 130 to 133, disks 140 to 147, a flash memory 150, and a control unit 160.

The channel adaptors 110 to 113 are respectively connected to host computers 10 to 13, and control transmission/reception of data therebetween. The cache memory 120 temporarily stores therein data that is retrieved from the host computers 10 to 13 or the disks 140 to 147. The cache memory 120 includes an encryption buffer 120a that stores therein encrypted data.

The disk I/Fs 130 to 133 are connected to the disks 140 to 147, and control transmission/reception of data (mainly encrypted data) therebetween. The disk I/Fs 130 to 133 check for errors in the data based on the cyclic redundancy check (CRC) included in the data. The disks 140 to 147 store therein data output from the disk I/Fs 130 to 133.

The flash memory 150 stores therein data required by the control unit 160. The flash memory 150 stores therein a master key 150a, an (encrypted) encryption key 150b, and a password 150c.

The master key 150a is commonly used among the RAID device 100 and other devices (other RAID devices or the like), and used to encrypt or decrypt the encryption key 150b created by the control unit 160. The encryption key 150b is encrypted with the master key 150a before being stored in the flash memory 150.

When the control unit 160 receives a request for the encryption key 150b, the control unit 160 determines whether to transmit the encryption key 150b to a request source by using the password 150c to verify the request source.

The control unit 160 includes an internal memory that stores therein computer programs for defining processing procedures and control data, and performs various processes based on the programs or the control data. Specifically, the control unit 160 includes a transmission/reception processing unit 160a, an encryption-key managing unit 160b, a write-back processing unit 160c, an encrypting unit 160d, an encryption-buffer adjusting unit 160e, and a decrypting unit 160f.

The transmission/reception processing unit 160a receives data output from the host computers 10 to 13, and stores the received data in the cache memory 120. In addition, in response to a request for the data stored in the cache memory 120 from the host computers 10 to 13, the transmission/reception processing unit 160a transmits the data to the host computers 10 to 13.

The encryption-key managing unit 160b creates an encryption key, and manages the created encryption key. Specifically, when an administrator of the RAID device 100 specifies a cryptosystem such as the Advanced Encryption Standard (AES) via any one the host computers 10 to 13, the encryption-key managing unit 160b creates an encryption key corresponding to the cryptosystem. The created encryption key is encrypted with the master key 150a, and stored in the flash memory 150.

Upon receiving a request for the encryption key 150b from any one of the host computers 10 to 13, the encryption-key managing unit 160b requests a request source (one of the host computers 10 to 13) to input a password. The encryption-key managing unit 160b verifies the password input by the request source with the password 150c stored in the flash memory 150. If the verification of the password is successful, the encryption-key managing unit 160b transmits the encryption key 150b to the request source.

The password 150c is previously registered in the encryption-key managing unit 160b by the administrator at the time the encryption-key managing unit 160b creates the encryption key.

The write-back processing unit 160c determines whether to write back the data stored in the cache memory 120. If the data is to be written back, the write-back processing unit 160c informs the encrypting unit 160d about the target data to be written back. The write-back processing unit 160c writes back the data, which has been encrypted by the encrypting unit 160d and stored in the encryption buffer 120a, to the disks 140 to 147. A space that has been occupied by the target data (the encrypted data) in the encryption buffer 120a is released after the write-back.

The write-back processing unit 160c performs a write-back of data, for example, but not limited to, after a predetermined time has elapsed from when the data was stored in the cache memory 120, or if the data is not used frequently.

When the write-back processing unit, 160c determines to perform the write-back, the encrypting unit 160d encrypts target data to be written back in the cache memory 120 at the timing when the write-back processing unit 160c performs the write-back. The encrypting unit 160d stores the encrypted data in the encryption buffer 120a.

Specifically, the encryption key 150b stored in the flash memory 150 is decrypted by the master key 150a, and the encrypting unit 160d encrypts the target data with the decrypted encryption key 150b. The encrypting unit 160d encrypts the target data based on the cryptosystem specified by the administrator in advance.

The target data includes a code such as a block check code (BCC) to detect a possible error. The BCC includes block identification (BID) that identifies a block on a disk to which data is to be written and the CRC. The encrypting unit 160d encrypts the target data except for the BCC. Namely, the encrypting unit 160d encrypts the minimum amount of data. Therefore, processing load on the encrypting unit 160d can be reduced.

When encrypting the target data, the encrypting unit 160d needs to recalculate the CRC included in the target data to perform CRC check. Without recalculation of the CRC and CRC check, processing load on the encrypting unit 160d can be further reduced.

The administrator can set whether the encrypting unit 160d recalculates the CRC and performs CRC check in advance. Alternatively, the encrypting unit 160d can determine whether to recalculate the CRC to perform CRC check based on the processing load on the encrypting unit 160d.

The encrypting unit 160d can encrypt the target data by using the BID in the BCC included in the target data instead of the encryption key. As a result, the encrypting unit 160d can be prevented from creating the same encrypted data because the BID is unique to each BCC.

The encryption-buffer adjusting unit 160e adjusts a capacity of a storage area in the encryption buffer 120a. Specifically, the encryption-buffer adjusting unit 160e obtains (or calculates) a usage rate of the storage area in the encryption buffer 120a at the timing when the write-back processing unit 160c performs the write-back. If the usage rate exceeds a threshold, the encryption-buffer adjusting unit 160e increases the storage area by a predetermined amount. Incidentally, it is assumed herein that the threshold and the value of the amount are set by the administrator in advance.

When encrypted data is loaded from any one of the disks 140 to 147 into the encryption buffer 120a, the decrypting unit 160f decrypts the encrypted data and stores the decrypted data in the cache memory 120. Specifically, the encryption key 150b stored in the flash memory 150 is decrypted with the master key 150a, and the decrypting unit 160f decrypts the encrypted data with the decrypted encryption key 150b.

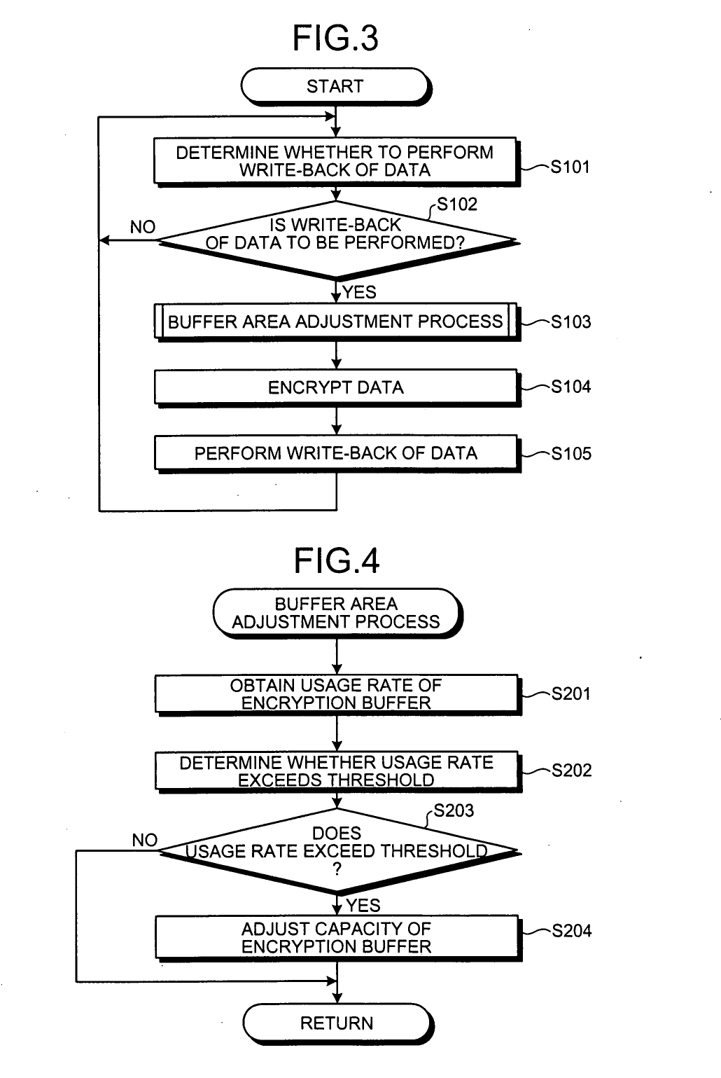

A data encryption process performed by the control unit 160 is described below with reference to FIG. 3. The write-back processing unit 160c determines whether to perform a write-back of data stored in the cache memory 120 (step S101).

If the write-back of data is not to be performed (No at step S102), the process returns to the step S101. If the write-back of data is to be performed (Yes at step S102), the encryption-buffer adjusting unit 160e performs adjustment of the storage area of the encryption buffer 120a, i.e., buffer area adjustment process (step S103).

The encrypting unit 160d encrypts the data, and stores the encrypted data in the encryption buffer 120a (step S104). The write-back processing unit 160c writes back the encrypted data stored in the encryption buffer 120a to the disks 140 to 147 (step S105). Then, the process returns to the step S101.

The buffer area adjustment process at the step S103 in FIG. 3 is described in detail with reference to FIG. 4. The encryption-buffer adjusting unit 160e obtains a usage rate of the encryption buffer 120a (step S201), and determines whether the obtained usage rate exceeds the threshold (step S202).

If the usage rate is below the threshold (No at step S203), the encryption-buffer adjusting unit 160e finishes the process. If the usage rate exceeds the threshold (Yes at step S203), the capacity or storage area of the encryption buffer 120a is increased (adjusted) by a predetermined amount (step S204). Then, the encryption-buffer adjusting unit 160e finishes the process.

As described above, the encrypting unit 160d encrypts data upon write-back of the data, i.e., background process regardless of the I/O processing from the upstream device. Thus, the data can be encrypted such that the upstream device is unaware of the encryption process.

In the RAID device 100 according to the embodiment, the encrypting unit 160d encrypts target data to be written back at the timing when the write-back processing unit 160c performs the write-back of data, and stores the encrypted data in the encryption buffer 120a. Then, the write-back processing unit 160c writes back the encrypted data stored in the encryption buffer 120a to the disks 140 to 147. Accordingly, the storage area in the encryption buffer 120a where the encrypted data has been stored is released. Therefore, the encrypting unit 160d can encrypt the target data without affecting the upstream device. Moreover, it is possible to use the storage area in the cache memory 120 efficiently.

The RAID device 100 can copy a disk (volume) in which non-encrypted data is stored onto another disk while encrypting the non-encrypted data. Specifically, the encrypting unit 160d retrieves the non-encrypted data from a disk, and stores the non-encrypted data in the cache memory 120 temporarily. Subsequently, the encrypting unit 160d encrypts the non-encrypted data. Then, the encrypting unit 160d writes back the encrypted data to another disk.

As just described, if data stored in a disk in the RAID device 100 is encrypted and then copied onto another disk, the data can be encrypted securely. In this case, after the encrypted data is copied to the other disk, the data stored in the original disk is deleted.

The RAID device 100 can specify whether data is to be encrypted by each of the disks 140 to 147 or by the logical unit number (LUN). For example, the administrator sets whether data is to be encrypted either by each of the disks 140 to 147 or by the LUN in advance. When the encrypting unit 160d encrypts data, the BID included in the target data is verified with information set by the administrator. Then, whether the data is to be encrypted is determined. If target data is to be encrypted, the RAID device 100 encrypts the target data.

The data is encrypted based on the determination result on each data basis. Therefore, if data is no need to be encrypted, the encrypting unit 160d can avoid unnecessary encryption of the data. Thus, processing load on the encrypting unit 160d can be reduced.

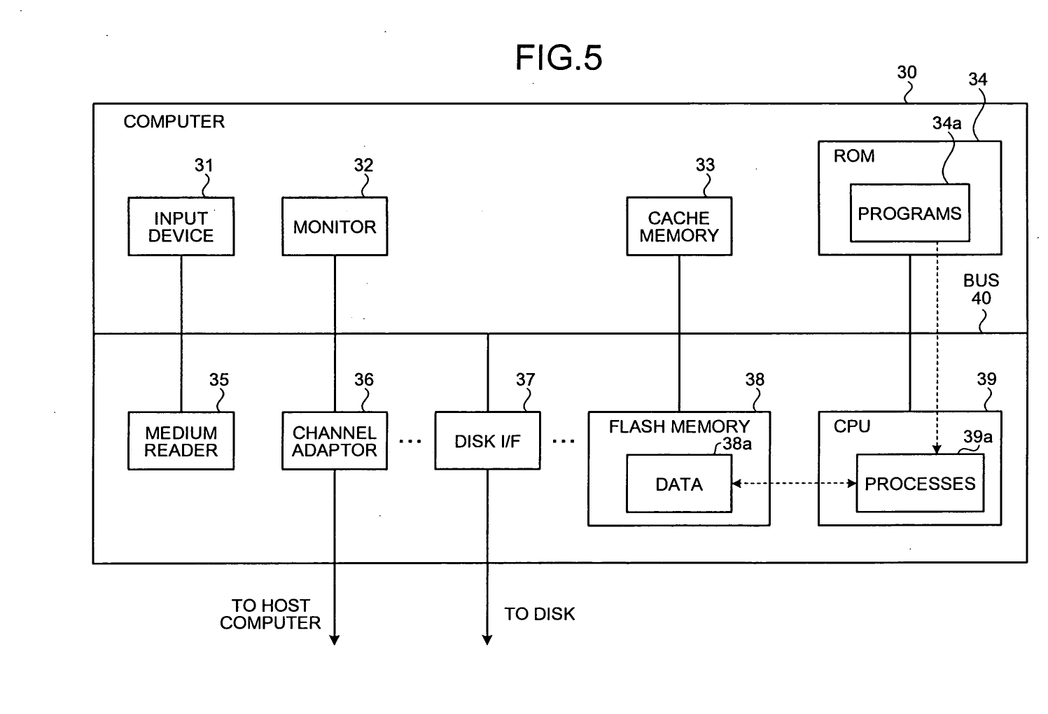

A computer program can be executed on a computer to realize the same function as the RAID device 100. Such a computer is described below with reference to FIG. 5.

FIG. 5 is a block diagram of a hardware configuration of a computer 30 that executes a computer program for implementing the RAID device 100. The computer 30 includes an input device 31, a monitor 32, a cache memory 33, a read-only memory (ROM) 34, a medium reader 35, a channel adaptor 36, a disk I/F 37, a flash memory 38, and a central processing unit (CPU) 39. Those components are connected to each other via a bus 40. The input device 31 receives data input by a user. The medium reader 35 reads a program from a recording medium. The channel adaptor 36 controls a data transmission/reception between a host computer and the computer 30. The disk I/F 37 controls data transmission/reception between a disk and the computer 30.

The ROM 34 stores therein programs 34a that implements the same function as the RAID device 100. The CPU 39 reads the programs 34a from the ROM 34 and executes them to activate processes 39a. The processes 39a correspond to the transmission/reception processing unit 160a, the encryption-key managing unit 160b, the write-back processing unit 160c, the encrypting unit 160d, the encryption-buffer adjusting unit 160e, and the decrypting unit 160f in the RAID device 100 (see FIG. 2).

The flash memory 38 stores therein data 38a that corresponds to data stored in the flash memory 150 in the RAID device 100. The CPU 39 performs a write-back of data by using the data stored in the flash memory 38.

The programs 34a are not necessarily stored in the ROM 34 in advance. The programs 34a can be stored in a portable physical medium to be connected to the host computer or a fixed physical medium inside or outside the host computer such as a hard disk drive (HDD). Examples of the portable physical medium include a flexible disk (FD), a compact disk read-only memory (CD-ROM), a digital versatile disk (DVD), a magnetic optical disk, and an integrated circuits (IC) card. The programs 34a can also be stored in other computer (or server) that is connected to the computer 30 via a network such as a public line, the Internet, a local area network (LAN), and a wide area network (WAN). Then, the computer 30 reads out a program from those recoding media, and executes the program.

Of the processes described in the embodiments, all or part of the processes explained as being performed automatically can be performed manually. Similarly, all or part of the processes explained as being performed manually can be performed automatically by a known method.

The processing procedures, the control procedures, specific names, various data, and information including parameters described in the embodiments or shown in the drawings can be changed as required unless otherwise specified.

The constituent elements of the device shown in the drawings are merely conceptual, and need not be physically configured as illustrated. The constituent elements, as a whole or in part, can be separated or integrated either functionally or physically based on various types of loads or use conditions.

The process functions performed by the device are entirely or partially realized by the CPU or computer programs that are analyzed and executed by the CPU, or realized as hardware by wired logic.

As set forth hereinabove, according to an embodiment of the present invention, upon receiving non-encrypted data from an upstream device via a network, a storage device stores the data in a primary storage unit of the storage device. When the data stored in the primary storage unit is to be written to a secondary storage unit of the storage device, the storage device encrypts the data and stores the encrypted data in the secondary storage unit. Therefore, the storage device can encrypt the data such that the upstream device is unaware of a delay in response to I/O processing from the upstream device due to the encryption of the data. The encrypted data is promptly written back to the secondary storage unit, so that the storage area in which the encrypted data has been stored is released. Thus, it is possible to use the storage area efficiently.

Moreover, an encryption key is encrypted and decrypted with a master key. Therefore, it is possible to protect the encryption key from being illegally used by a malicious third party.

Furthermore, the storage device does not encrypt data such as an error detecting code, which is used to detect errors in target data to be written back, included in the target data. Therefore, processing load on the storage device can be reduced.

Moreover, the storage device adjusts the capacity or storage area of the primary storage unit in which the encrypted data is stored based on the usage rate of the storage area. Therefore, it is possible to prevent a delay in processing due to insufficient available storage capacity.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A storage device that includes a primary storage unit and a secondary storage unit, the storage device being connected to an upstream device via a network, the storage device comprising:
a first data processing unit that receives non-encrypted data from the upstream device and temporarily stores the non-encrypted data in the primary storage unit; and
a second data processing unit that encrypts the non-encrypted data, and writes encrypted data to the secondary storage unit.

2. The storage device according to claim 1, further comprising a key creating unit that creates an encryption key, and encrypts the encryption key with a master key used to decrypt encrypted encryption key, wherein
the second data processing unit encrypts the non-encrypted data with the encryption key.

3. The storage device according to claim 1, wherein
the non-encrypted data stored in the primary storage unit includes error detecting data that is used to detect an error in the non-encrypted data, and
the second data processing unit encrypts the non-encrypted data except for the error detecting data.

4. The storage device according to claim 1, wherein the first data processing unit temporarily stores the non-encrypted data in a first area in the primary storage unit, the second data processing unit stores the encrypted data in a second area in the primary storage unit and writes the encrypted data in the second area to the secondary storage unit, the storage device further comprising:
an adjusting unit that adjusts a capacity of the second area based on a usage rate of the second area.

5. The storage device according to claim 1, wherein the second data processing unit writes the encrypted data to the secondary storage unit at a predetermined timing.

6. The storage device according to claim 5, wherein the second data processing unit writes the encrypted data to the secondary storage unit after a predetermined time elapses from when the non-encrypted data is stored in the primary storage unit.

7. A computer-readable recording medium that stores therein a computer program that causes a computer to transfer data from a primary storage unit to a secondary storage unit of a storage device, the storage device being connected to an upstream device via a network, the computer program causing the computer to execute:
receiving non-encrypted data from the upstream device;
storing the non-encrypted data in the primary storage unit;
encrypting the non-encrypted data; and
writing encrypted data to the secondary storage unit.

8. The computer-readable recording medium according to claim 7, wherein the computer program further causing the computer to execute:
creating an encryption key; and
encrypting the encryption key with a master key used to decrypt encrypted encryption key, wherein
the encrypting the non-encrypted data includes encrypting the non-encrypted data with the encryption key.

9. The computer-readable recording medium according to claim 7, wherein
the non-encrypted data stored in the primary storage unit includes error detecting data that is used to detect an error in the non-encrypted data, and
the encrypting including encrypting the non-encrypted data except for the error detecting data.

10. The computer-readable recording medium according to claim 7, wherein
the storing includes storing the non-encrypted data in a first area in the primary storage unit,
the encrypting includes storing the encrypted data in a second area in the primary storage unit, and
the writing includes writing the encrypted data in the second area to the secondary storage unit, the computer program further causing the computer to execute:
adjusting a capacity of the second area based on a usage rate of the second area.

11. The computer-readable recording medium according to claim 7, wherein the writing includes writing the encrypted data to the secondary storage unit at a predetermined timing.

12. The computer-readable recording medium according to claim 11, wherein the writing further includes writing the encrypted data to the secondary storage unit after a predetermined time elapses from when the non-encrypted data is stored in the primary storage unit.

13. A write-back method for transferring data from a primary storage unit to a secondary storage unit of a storage device, the storage device being connected to an upstream device via a network, the write-back method comprising:
receiving non-encrypted data from the upstream device;
storing the non-encrypted data in the primary storage unit;
encrypting the non-encrypted data; and
writing encrypted data to the secondary storage unit.

14. The write-back method according to claim 13 further comprising:
creating an encryption key; and
encrypting the encryption key with a master key used to decrypt encrypted encryption key, wherein
the encrypting the non-encrypted data includes encrypting the non-encrypted data with the encryption key.

15. The write-back method according to claim 13, wherein
the non-encrypted data stored in the primary storage unit includes error detecting data that is used to detect an error in the non-encrypted data, and
the encrypting including encrypting the non-encrypted data except for the error detecting data.

16. The write-back method according to claim 13, wherein
the storing includes storing the non-encrypted data in a first area in the primary storage unit,
the encrypting includes storing the encrypted data in a second area in the primary storage unit, and
the writing includes writing the encrypted data in the second area to the secondary storage unit, the write-back method further comprising:
adjusting a capacity of the second area based on a usage rate of the second area.

17. The write-back method according to claim 13, wherein the writing includes writing the encrypted data to the secondary storage unit at a predetermined timing.

18. The write-back method according to claim 17, wherein the writing further includes writing the encrypted data to the secondary storage unit after a predetermined time elapses from when the non-encrypted data is stored in the primary storage unit.
